(19) United States
(12) Patent Application Publication
(10) Pub. No.: US 2021/0386210 A1
(43) Pub. Date: Dec. 16, 2021

(54) POCKETED SPRING UNIT AND METHOD AND APPARATUS FOR FORMING THE SAME

(71) Applicant: HS PRODUCTS LIMITED, Leeds, West Yorkshire (GB)

(72) Inventors: Simon SPINKS, Leeds, West Yorkshire (GB); David CLARE, Leeds, West Yorkshire (GB); Darren MARCANGELO, Leeds, West Yorkshire (GB); Richard ESSERY, Leeds, West Yorkshire (GB)

(21) Appl. No.: 16/637,340

(22) PCT Filed: Aug. 10, 2018
(86) PCT No.: PCT/GB2018/052278

§ 371 Date: Feb. 7, 2020

(30) Foreign Application Priority Data
Aug. 15, 2017 (GB) 1713096.4

(51) Int. Cl. A47C 27/06; B29C 65/30; B29C 65/22; B29C 65/74; B68G 9/00

(52) U.S. Cl. CPC A47C 27/064; B29C 65/30; B29L 2031/7742; B29C 65/7451; B68G 9/00; B29C 65/22

(57) ABSTRACT

Apparatus for forming a pocketed spring unit, comprising a plurality of strings of pocketed springs and at least one cover sheet, comprises welding tools for welding together the pocketing material and the sheet. One of the welding tools is provided with a cutter for cutting the pocket prior to welding. The tool travels in the direction of Arrow A1, so that the cutter penetrates the pocketing material substantially centrally at the circular proximal end face of the pocket. Once inside the pocket, the tool moves axially through the centre of the spring until it reaches the distal end face of the pocket. Before the end face is reached, the piercing member becomes retracted in the direction of Arrow A2, so that the blade does not pierce the distal end face of the pocket.

The present invention relates to a pocketed spring unit and to a method and an apparatus for forming the same, and is concerned particularly with a pocketed spring unit that is substantially free from adhesive, and to a method and apparatus for forming such a unit.

Pocketed springs, otherwise known as encased springs, are used in upholstered articles such as mattresses. Most pocketed spring units comprise coil springs encased individually in pockets of fabric material formed by folding over a sheet of fabric to form two leaves that envelope the springs, and then attaching the leaves together between the springs so as to form a string of springs. The strings are then joined to form an array of springs as a pocketed spring unit. The joining of the strings together to form an array is achieved either by gluing the strings together along the cylindrical surfaces of the pocketed springs, one string to the next, and so on until the unit is formed, or else by arranging the strings beside each other in the manner of an array, and then gluing sheets of fabric to the cylindrical ends of the pocketed springs, above and below, so as to form the unit.

A problem with either method is the extensive use of glue to hold together the strings, to form the unit. For one thing the adhesive forms a significant element of the cost of manufacturing a pocketed spring unit, and for another the presence of the adhesive in the product makes it difficult to recycle.

Embodiments of the present invention aim to provide a pocketed spring unit, and a method and apparatus for manufacturing the same, in which the shortcomings of the prior art are addressed.

The present invention is defined in the attached independent claims, to which reference should now be made. Further, preferred features may be found in the sub-claims appended thereto.

According to one aspect of the present invention, there is provided a method of forming a pocketed spring unit comprising a plurality of strings of pocketed springs and an attached cover sheet, the method comprising welding pocketing material to the cover sheet using first and second welding tools, and wherein a first welding tool is arranged to enter a pocket through an end face of the pocket prior to welding.

A second welding tool may be placed to the exterior of the pocket, on another side of the cover sheet, for cooperation with the first welding tool, so that during welding the first and second welding tools press the pocketing material and the cover sheet between them to effect the weld.

The first welding tool may be arranged to pierce the material of the end face of the pocket prior to welding.

In a preferred arrangement, the first welding tool is arranged to pierce the pocket at a first end face and to weld the pocket to the cover sheet at a second, axially opposed end face of the pocket.

The method may include welding a cover sheet to both sides of the unit, so that at each axial end face of the pocket it is welded to an external cover sheet. The method may include penetrating the pocket through each of its end faces with a first welding tool, wherein each first welding tool then travels to the axially opposed end face of the pocket and welds it to a cover sheet, by cooperation with respective second welding tools.

Preferably the method comprises welding a plurality of pockets to the sheet substantially simultaneously. The method preferably comprises welding multiple pockets of a string to the cover sheet before indexing the unit, introducing the next string and repeating the welding operation.

According to another aspect of the present invention there is provided a pocketed spring unit, the unit comprising a plurality of strings of pocketed springs and at least one cover sheet, and wherein at least some of the pockets are joined to the cover sheet at their end faces by welds.

The invention also provides apparatus for forming a pocketed spring unit comprising a plurality of strings of pocketed springs and at least one cover sheet, the apparatus comprising first and second welding tools for welding together the pocketing material and the sheet, and wherein the first welding tool is provided with a cutter for cutting the pocket prior to welding, wherein the first welding tool is arranged in use to cut the pocket, enter the pocket and weld the pocket to the cover sheet.

In a preferred arrangement, the first welding tool is arranged in use to penetrate the pocket at a first, proximal axial end face, to travel to a second, axially opposed distal end face of the pocket and then to effect a weld there by cooperation with the second welding tool.

The cutter is preferably retractable so as not to cut the second end face of the pocket.

The apparatus may comprise two of the first tools and two of the second tools, such that in use the pocket is arranged to be penetrated at each end by respective first tools and welded at each opposed end by the same tool, each first tool cooperating with a second tool to weld the pocket material to respective cover sheets on opposed sides of the unit.

Preferably the apparatus is arranged in use to weld multiple pockets of a string to at least one cover sheet substantially simultaneously.

According to another aspect of the present invention, there is provided a method of forming a pocketed spring unit comprising a plurality of strings of pocketed springs, the method comprising joining at least some strings together by welding, wherein the welding is carried out by a welding tool that pierces an end face of the pocket prior to welding.

The method may comprise joining the strings together substantially directly.

Alternatively, or in addition, the method may comprise joining the strings together indirectly via a cover sheet.

According to another aspect of the present invention there is provided a pocketed spring unit, the unit comprising a plurality of strings of pocketed springs joined together, wherein at least some of the pocketed springs comprise an aperture in a an end face of the pocket for receiving a welding tool.

The strings may be joined together directly. Alternatively, or in addition, the strings may be joined together indirectly via a cover sheet.

The invention also provides apparatus for forming a pocketed spring unit comprising a plurality of strings of pocketed springs, the apparatus comprising at least a first welding tool for joining the strings, which welding tool is arranged to penetrate an end face of a pocket prior to welding.

The apparatus may be arranged in use to join the strings substantially directly. Alternatively, or in addition, the apparatus may be arranged in use to join the strings indirectly, via a cover sheet.

In a further aspect, the invention provides a computer programme product on a computer readable medium, comprising instructions that, when executed by a computer, cause the computer to perform a method according to any statement herein.

The invention also comprises a program for causing a device to perform a method according to any statement herein.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

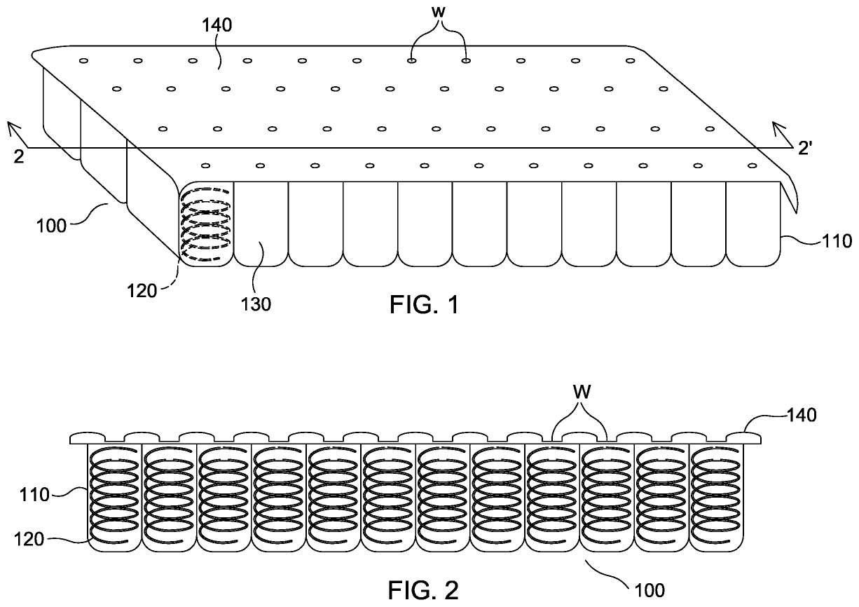

FIG. 1 shows in schematic perspective view a pocketed spring unit in accordance with an embodiment of the present invention;

FIG. 2 is a schematic sectional view of the unit of FIG. 1, taken along line 2-2′ of FIG. 1;

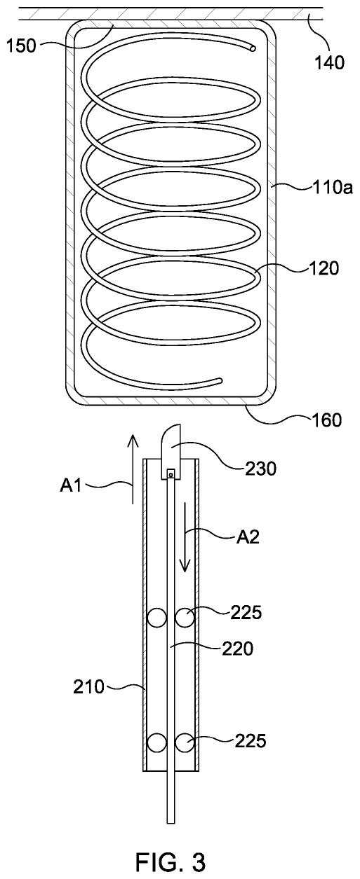

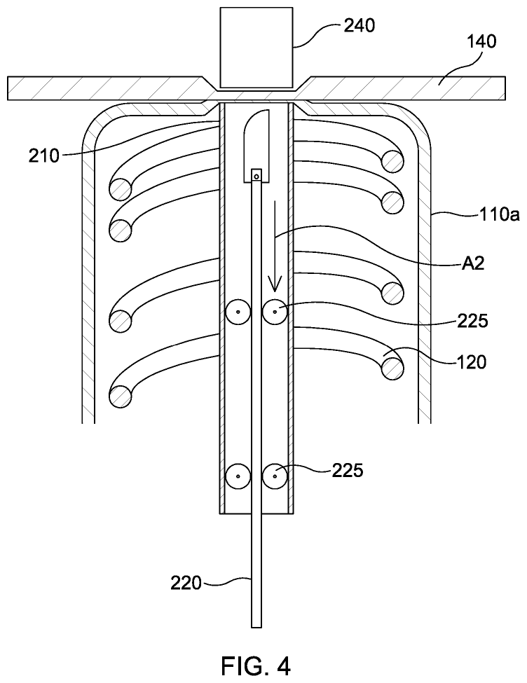

FIG. 3 shows schematically, in sectional view, a part of the unit of FIGS. 1 and 2 during an initial stage in a welding operation; and

FIG. 4 shows schematically part of the unit of FIG. 3 during a subsequent stage of a welding operation.

Turning to FIGS. 1 and 2, these show, generally at 100, a pocketed spring unit such as may be used in, or as, a mattress or similar, in accordance with an embodiment of the present invention.

The pocketed spring unit 100 comprises a plurality of strings 110 of pocketed springs. Each string 110 comprises a number of wire coil springs 120, each located within its own discrete pocket of material 130. The material may be a weldable, nonwoven material, such as spun-bonded polyester. The strings are typically formed by folding a sheet of pocketing material over a plurality of springs and ultrasonically welding the sheet along its free edges and between the adjacent springs to produce a linear “string”.

The strings are each attached to a common cover sheet 140 at a number of welding locations W, by one of a number of methods, an example of which will be given below.

FIG. 3 shows schematically an early stage of a welding operation which occurs in the manufacturing of the unit 100 of FIGS. 1 and 2. One pocket 110a of the string 110 is shown in section, with the spring 120 exposed therein. The cover sheet 140 is located at a distal axial end of the spring above a substantially circular end face 150 of the pocket 110a.

At an opposed, proximal circular end face of the same pocket 110a is a welding tool 200. The tool 200 comprises a hollow, generally tube-like welding body 210 within which is located a retractable cutter 220 mounted on bearings 225 for axial movement within body 210. The cutter has a piercing member 230, which in this example is in the form of a blade, at a distal end.

The body 210 is connected to a supply of electrical power (not shown) and is used to effect a welding of the pocket material to the cover sheet.

In the configuration shown in FIG. 3, the tool 200 is about to travel in the direction of Arrow A1, so that the piercing member 230 will penetrate the pocketing material substantially centrally at the circular proximal end face 160 of the pocket 110a. Once inside the pocket 110a, the tool 200 will move axially through the centre of the spring 120 until it reaches the distal end face 150 of the pocket. Before the end face 150 is reached, the piercing member will be retraced in the direction of Arrow A2, so that the blade does not pierce the distal end face 150 of the pocket 110a.

FIG. 2 shows a later stage of the welding operation. The cutter 220 has been retracted and the pocketing material of end face 150 has become compressed together with the cover sheet 140, against a complementary welding tool 240. When the electrically connected welding body 210 and tool 240 come together, an electrical signal in the tools causes the pocketing material and cover sheet to become heated locally and to thus weld together. The weld completed, the tools 200 and 240 are separated and the former is withdrawn from the pocket through the hole (not shown) that it initially created.

This operation is conducted for each of the pocketed springs in the string, substantially simultaneously, before the unit is indexed and a new string is introduced alongside the one just welded. The operation is repeated until the unit is formed to the desired length.

The number and position of welds ensures that a strong bond is made between the strings and the cover sheet.

Other types of welding may be used.

Because of the position of the welds, substantially centrally of the generally circular end faces of the pockets, the thickness of the material is known and a reliably consistent weld can be achieved.

In the example shown in the drawings there is a single cover sheet on one side of the unit. However in an alternative embodiment (not shown) a cover sheet can be joined at each end of the pocketed springs, so as to form a pocketed spring unit having a cover sheet above and below the springs.

Furthermore, whilst a single set of welding tools is shown in the drawings, other variants are possible within the scope of the invention. For example, a first welding tool can be inserted at each end of the pocket and be made to cooperate with a second tool, on the other side of a cover sheet at the opposed axial end face of the pocket. This can be achieved substantially simultaneously or else in separate steps.

In alternative embodiments (not shown) the welding tools can operate differently from the arrangements described above. For example, the tool that penetrates the pocket can be made to retract or turn, for example through substantially 90 degrees, or else to deploy one or more retractable flaps, so as to present a welding support surface (commonly referred to as an anvil) below the same end of the pocket that has been pierced. In this case a complementary welding tool can be made to press the sheet and pocket material together at the end that has been pierced, before welding the two together.

One of the two complementary welding tools can be a so-called hot wire, and the other tool an anvil.

In another embodiment (not shown), two sets of tools are used so that each set pierces a row of pockets. Then these tools are brought together, pressing adjacent rows of pockets together, with one set of tools providing the welding energy/signal, such as heat. This creates welds inside the pockets, between the substantially cylindrical surfaces of the pockets in adjacent strings. Once in the pocket the tools could move to new positions to create multiple welds inside the pocket, with three such welds being seen as a good compromise between strength and cost of manufacture. Again, the welding operation can be conducted from either end, or indeed both ends, of the springs, for example substantially simultaneously, or sequentially.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A method of forming a pocketed spring unit comprising a plurality of strings of pocketed springs and an attached cover sheet, the method comprising welding pocketing material to the cover sheet using first and second welding tools, and wherein a first welding tool is arranged to enter a pocket through an end face of the pocket prior to welding.

2. A method according to claim 1, wherein a second welding tool is placed to the exterior of the pocket, on another side of the cover sheet, for cooperation with the first welding tool, so that during welding the first and second welding tools press the pocketing material and the cover sheet between them to effect the weld.

3. A method according to claim 1, wherein the first welding tool is arranged to pierce the material of the end face of the pocket prior to welding.

4. A method according to claim 1, wherein the first welding tool is arranged to pierce the pocket at a first end face and to weld the pocket to the cover sheet at a second, axially opposed end face of the pocket.

5. A method according to claim 1, comprising welding a cover sheet to both sides of the unit, so that at each axial end face of the pocket it is welded to an external cover sheet.

6. A method according to claim 1, comprising penetrating the pocket through each of its end faces with a first welding tool, wherein each first welding tool then travels to the axially opposed end face of the pocket and welds it to a cover sheet, by cooperation with respective second welding tools.

7. A method according to claim 1, comprising welding a plurality of pockets to the sheet substantially simultaneously.

8. A method according to claim 1, comprising welding multiple pockets of a string to the cover sheet before indexing the unit, introducing the next string and repeating the welding operation.

9. A pocketed spring unit, the unit comprising a plurality of strings of pocketed springs and at least one cover sheet, and wherein at least some of the pockets are joined to the cover sheet at their end faces by welds.

10. Apparatus for forming a pocketed spring unit comprising a plurality of strings of pocketed springs and at least one cover sheet, the apparatus comprising first and second welding tools for welding together the pocketing material and the sheet, and wherein the first welding tool is provided with a cutter for cutting the pocket prior to welding, wherein the first welding tool is arranged in use to cut the pocket, enter the pocket and weld the pocket to the cover sheet.

11. Apparatus according to claim 10, wherein the first welding tool is arranged in use to penetrate the pocket at a first, proximal axial end face, to travel to a second, axially opposed distal end face of the pocket and then to effect a weld there by cooperation with the second welding tool.

12. Apparatus according to claim 10, wherein the cutter is retractable so as not to cut the second end face of the pocket.

13. Apparatus according to claim 10, wherein the apparatus comprises two of the first tools and two of the second tools, such that in use the pocket is arranged to be penetrated at each end by respective first tools and welded at each opposed end by the same tool, each first tool cooperating with a second tool to weld the pocket material to respective cover sheets on opposed sides of the unit.

14. Apparatus according to claim 10, wherein the apparatus is arranged in use to weld multiple pockets of a string to at least one cover sheet substantially simultaneously.

15. A method of forming a pocketed spring unit comprising a plurality of strings of pocketed springs, the method comprising joining at least some strings together by welding, wherein the welding is carried out by a welding tool that pierces an end face of the pocket prior to welding.

16. A method according to claim 15, comprising joining the strings together substantially directly.

17. A method according to claim 15, comprising joining the strings together indirectly via a cover sheet.

18. A pocketed spring unit, the unit comprising a plurality of strings of pocketed springs joined together, wherein at least some of the pocketed springs comprise an aperture in at an end face of the pocket for receiving a welding tool.

19. Apparatus for forming a pocketed spring unit comprising a plurality of strings of pocketed springs, the apparatus comprising at least a first welding tool for joining the strings, which welding tool is arranged to penetrate an end face of a pocket prior to welding.
